(19) United States
(12) Patent Application Publication
(10) Pub. No.: US 2011/0209320 A1
(43) Pub. Date: Sep. 1, 2011

(54) Vision Guided Robotic Grommet Installation

(75) Inventor: Brian E. Connolly, Macomb, MI (US)

(73) Assignee: ABB INC., Cary, NC (US)

(21) Appl. No.: 13/033,949

(22) Filed: Feb. 24, 2011

Related U.S. Application Data
(60) Provisional application No. 61/308,324, filed on Feb. 26, 2010.

(51) Int. Cl. B23Q 17/00; B23P 21/00

(52) U.S. Cl. 29/407.04; 29/705

(57) ABSTRACT

A system and method installs grommets into vehicle grommet holes using vision a six axis robot with a grommet tool and a vision system. The robot arm moves to the general area of a grommet hole and then the vision system determines the exact hole location. Thereafter, the robot moves the grommet tool to the hole to install the grommet. Installation is then confirmed by the vision system.

### CROSS-REFERENCE TO RELATED APPLICATION

This application claims the benefit of U.S. Provisional Patent Application No. 61/308,324, titled Vision Guided Robotic Grommet Installation and filed on Feb. 26, 2010, which is hereby incorporated by reference in its entirety.

### BACKGROUND

Grommets are generally metal, plastic or rubber discs that may be inserted into a hole in an object. Grommets may be used to reinforce, seal or protect and cover the edges of the hole. Automobiles commonly include 50 or more holes that require an installed grommet. If 60 cars are assembled per hour, for 8 hrs in a day, a person could install 24,000 grommets per day. This number is compound by the amount of force that is required for grommet installation, which is approximately 100 Newtons. Given the volume and force required, the fatigue and repetitive stress injuries to individuals become problematic.

Accordingly, there is a need in the art for an automated grommet installation system that eliminates need for human installers.

### SUMMARY OF THE INVENTION

According to one aspect of the present invention, a method is provided for installing grommets into holes in a vehicle body using a robot system including a grommet supplier, a vision system including a vision system controller and an imaging device, and a robot having a robot arm that carries a tool and the imagine device. The method includes moving the tool to the grommet supplier and capturing a plurality of grommets using the tool. The imaging device is moved proximate to a first grommet hole in the vehicle body. The first grommet hole is then imaged by the imagine device to determine a first hole location. The tool is moved to the first hole location and a grommet is installed in the first grommet hole. The imagine device is then moved proximate the first grommet hole where it images the first grommet hole to determine whether the installation of the grommet was successful.

According to another aspect of the present invention, a robot system is provided for installing grommets into holes in a vehicle body. The robot system includes a grommet supplier having a hopper and a positioning mechanism. A robot includes a robot arm. A vision system includes a vision system controller and an imaging device, the imaging device is carried by the robot arm. A tool is carried by the robot arm, the tool includes a plurality of projections. Each projection has a shaped end sized to carry a grommet. A robot controller for controls the robot and is adapted to command the robot arm to move the tool to the grommet supplier. The controller commands the robot arm to position the tool to capturing a plurality of grommets. The controller commands the robot arm to move the imaging device proximate to a first grommet hole in the vehicle body. The controller receive a first hole location from the vision system controller. The controller commands the robot arm to move the tool to the first hole location and install a grommet in the first grommet hole. After installing the grommet, the controller commands the robot arm to move the imaging device proximate to the first grommet hole. The controller receives a notification from the vision system controller whether the grommet installation was successful. If the grommet installation was not successful, the controller commands the robot arm to again move the tool to the first hole location and install a grommet in the first grommet hole.

### BRIEF DESCRIPTION OF THE DRAWINGS

FIG. 1 shows a perspective view of an exemplary work area wherein the present invention is practiced, including a robot, grommet supplier and vehicle body.

FIG. 2 shows a side view of the grommet supplier according to the present invention.

FIG. 3 shows a front view of the grommet supplier and tool according to the present invention.

FIG. 4 shows a schematic view of the main system controller, robot controller and vision system controller according to the present invention.

FIG. 5 shows a flow chart of the grommet installation process according to the present invention.

### DETAILED DESCRIPTION OF THE PRESENT INVENTION

Generally, the present invention includes a process using a material handling robot(s) to install body sealing grommets or hole-plugs into holes in a vehicle. In operation, the robots are vision guided to find the location of the car body, install the grommets and then verify correct installation. Historically the issue with automating grommet installation has been hole location variation in a vehicle. In some instances, hole location can vary by approximately 5 to 25 mm in the x, y, and/or z planes. The present invention eliminates the hole location issue associated with the installation of grommets.

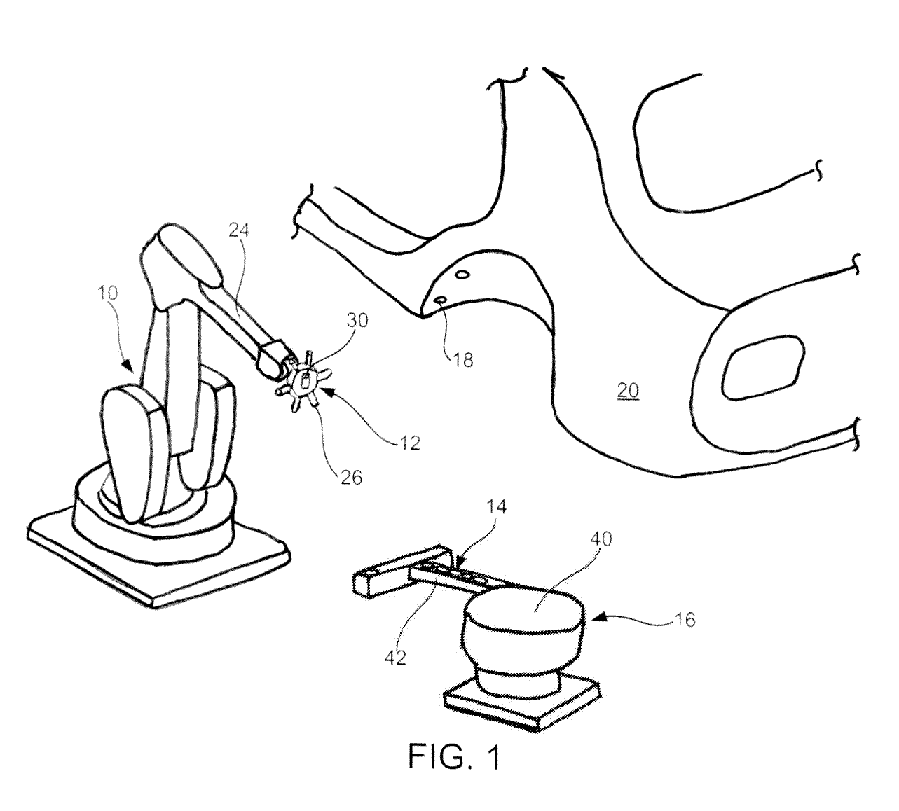

With reference now to FIG. 1, the system may include a robot 10. According to one embodiment, robot 10 is a six axis robot. Robot 10 includes a grommet tool 12 that selectively captures and installs grommets 14. The grommet tool 12 receives grommets from a grommet supplier 16 and installs the grommets 14 in holes 18 in a vehicle 20. It should be appreciated that, though FIG. 1 shows a single robot 10, multiple robots may be used simultaneously during a single vehicle assembly. For example, two robots 10 may be positioned on each side of the vehicle 20. Further, each robot 10 may include a separate corresponding grommet supplier 16. In other embodiments, a single grommet supplier 16 may provide grommets 14 to two or more robots 10.

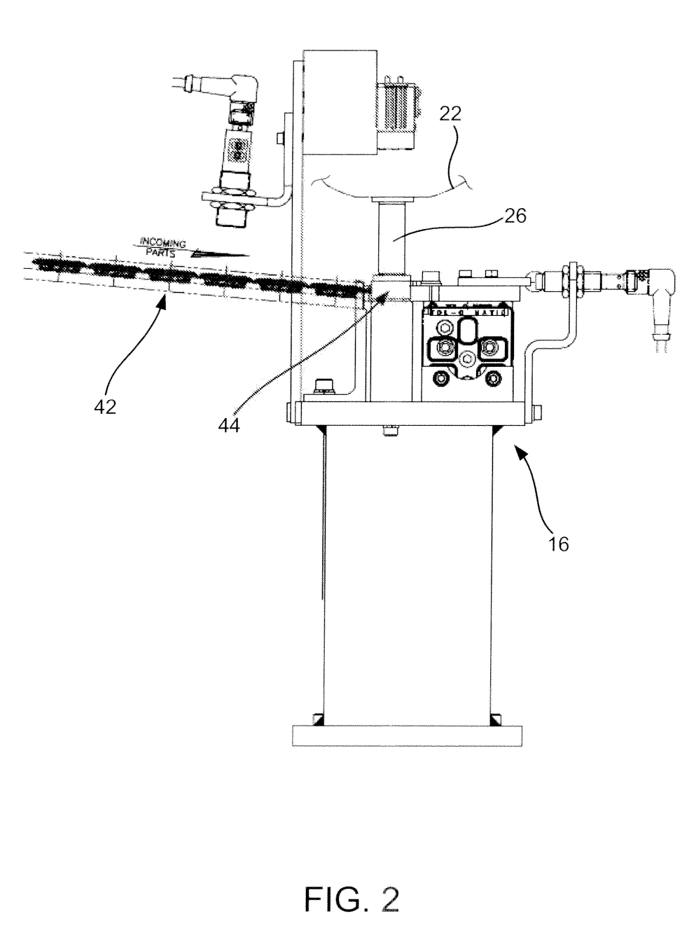

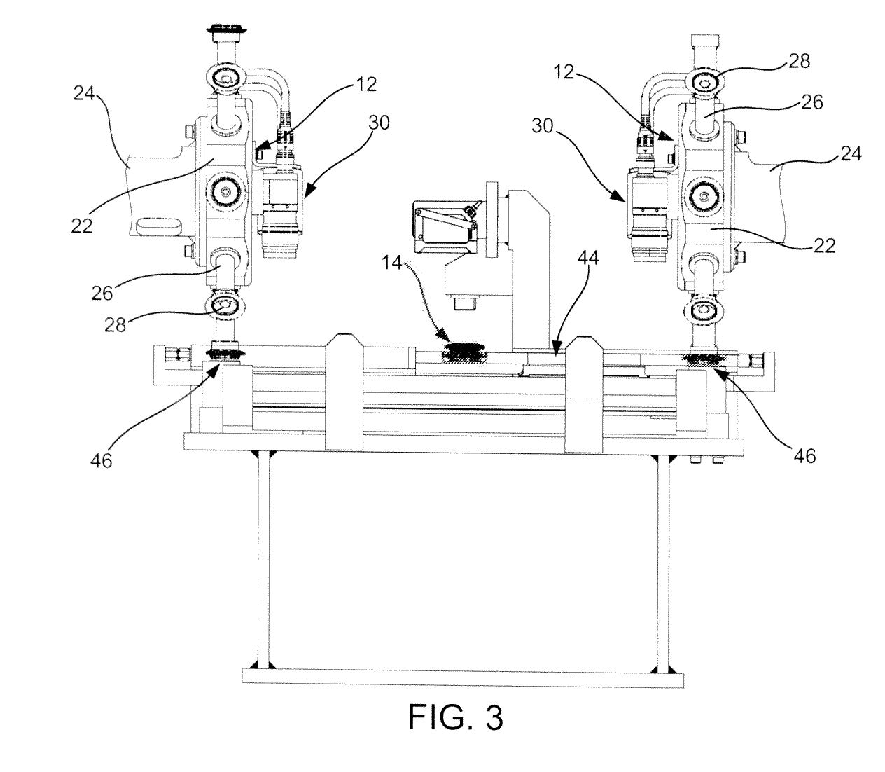

With reference now to FIGS. 2 and 3 the grommet supplier 16 and tool 12 are shown in greater detail. According to one aspect of the present invention, the tool 12 includes a generally ring shaped body 22 that is rotatable relative to the robot arm 24. Body 22 supports a plurality of circumferentially spaced projections 26. According to one embodiment, eight projections are included, however, it should be appreciated that any number may be used. Each projection 26 includes a shaped end 28 that is sized receive and capture a single grommet 14. A vacuum source may be provided at the shaped end 28 to ensure solid capture of the grommet 14 therein. According to one embodiment, a vacuum sensor (not shown) may be provided that determines whether a grommet 14 is secured in shaped end 28 based on a pressure signal.

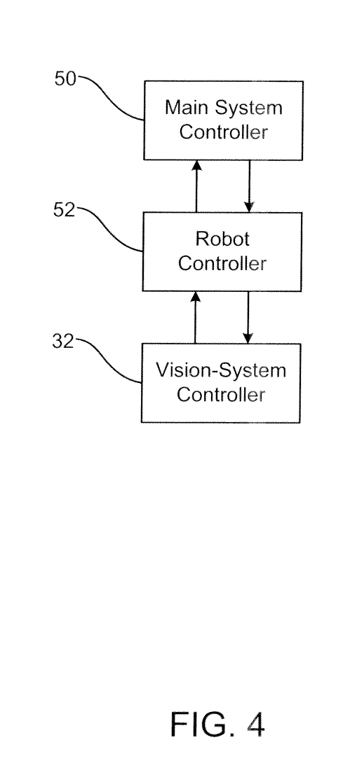

An imaging device 30 is secured to robot 10 on the opposed side of tool 12 from arm 24. As will be described later in greater detail, imagine device 30 communicates with a vision system controller 32 (see FIG. 4) to determine hole location for grommet 14 installation. According to one embodiment, imaging device 30 is secured to tool 12 and rotates therewith. According to another embodiment, imaging device 30 may be mechanically coupled to arm 24 so that when tool 12 rotates relative to arm 24, the imagine device does not rotate. According to one embodiment, the imaging device and controller are the ABB TrueView 2.5D vision system.

The grommet supplier 16 includes a hopper 40 within which a relatively large number of grommets 14 may be stored. Grommets 14 travel from hopper 40 along a feeder track 42 to a central position on a positioning track 44. From the central position, grommets 14 are moved outwardly to one of the opposed ends 46 of positioning track 44. Grommets 14 may be moved along positioning track 44 by any means including mechanical, hydraulic, pneumatic actuation. According to one embodiment, grommets 14 are carried on a shuttle along track 44 to either end 46. Grommets 14 are stopped at the ends 46 of each positioning track 44. As can be seen in FIG. 3, when in the track ends 46, tool 12 may capture the grommet 14. Grommet supplier 16 may include one or more proximity or photo-electric switches to determine when grommets 14 are in position and available for picking by tool 12.

In operation a signal is sent from a main system controller 50 to the ABB robot controller 52 indicating that the robot 10 may proceed with the installation of the grommets. Thereafter, the robot controller 52 in conjunction with the vision system controller, controls the robot to install the grommets and perform a quality check. The robot 10 then returns to the grommet supplier 16 and re-loads for the next vehicle 20.

Grommets 14 may be picked by the robot 10 in the following manner. The robot controller 52 commands robot 10 to move the tool 12 to the grommet supplier 16. Next, the vacuum generator on robot 10 is activated to draw a vacuum at the shaped ends 28 of each projection on the tool 12. The robot 10 then moves one of the plurality of projections 26 into contact with a grommet 14 located at track end 46. The robot arm 24 is then lifted away from grommet supplier 16, thereby drawing grommet 14 out of the positioning track 44. Thereafter, the tool 12 rotates to align another projection 26 with the track end 46 to capture another grommet 14. At the same time the shuttle returns to the central position, retrieves another grommet 14, and then returns to the track end 46.

After robot 10 has retrieved all of the grommets 14 that the tooling is capable of holding, the robot controller 52 signals the main system controller 50 that robot 10 is carrying a full load of grommets 14. The main system controller 50 then signals robot controller 52 that robot 10 may move the grommets 14 to the vehicle 20 and proceed to install the grommets 14 into the vehicle 20. The robot 10 then moves the tool 12 to a first pre-programmed installation position. First pre-programmed installation position corresponds to the general location of a first grommet hole 18 on vehicle 20. Specifically, the first pre-programmed installation position is a location proximate to the first grommet hole 18 in an orientation that imaging device 30 can effectively image the hole 18.

While in the first pre-programmed installation position, the imaging device 30 is activated and an image of the hole in three dimensions is recorded. The vision system controller 32 then determines the exact tool 12 position for grommet installation. The vision system controller 32 then feeds the hole 18 position information to the robot controller 52 which in turn commands the robot arm 24 to move the tool 12 in position over the hole 18 and then installs the grommet 14 into the hole 18. The robot 10 then moves the tool 12 away from the grommet 14, releasing it, at which point the vacuum to that shaped end 28 may be discontinued. The robot 10 then repositions the imaging device 30 over the installed grommet and verifies that the grommet 14 was installed into the vehicle 20 with verification confirmed by looking to see if the grommet 14 is present or not. With the first grommet installed the robot moves to a next pre-programmed position corresponding to the next grommet hole and repeats the above outlined steps.

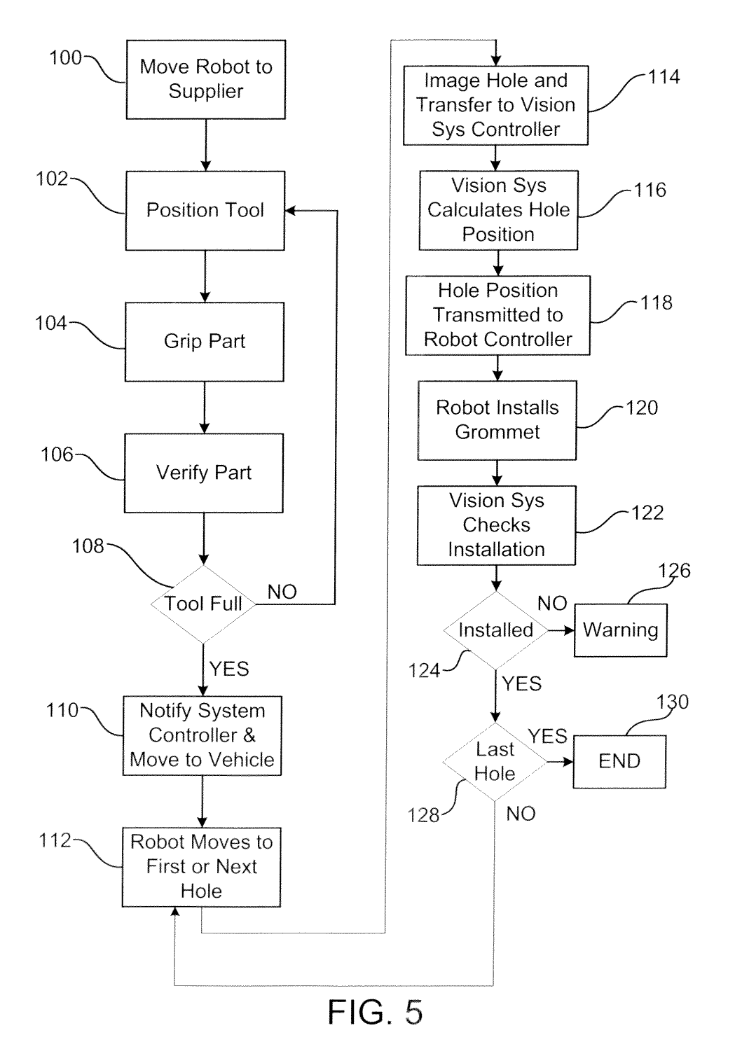

With reference now to FIG. 5, a flow chart is shown describing the process according to the present invention. It should be appreciated that, for the following description, each movement by robot 10 is directed by robot controller 52. At a first step 100 the robot 10 moves to the grommet supplier 16. At 102 the robot 10 positions tool 12 over end position 46 of supplier 16 and lowers the tool 12 so that a shaped end 28 engages a grommet 14. At 104 a vacuum is drawn at shaped end 28 to grip the grommet 14 within the shaped end 28. At 106 the vacuum switch (based on sensed pressure) determines whether a grommet 14 is carried within the shaped end 28. At 108 it is determined whether the tool is full. If not, the process returns to step 102 where the tool 12 is positioned so that a shaped end 28 without a grommet 14 is positioned over end position 46.

If the tool 12 is full, at 110 the robot controller 52 notifies the system controller 50 that the tool 12 is full. The system controller 50, may then direct the robot controller 52 to proceed and the robot 10 moves tool 12 to the vehicle 20. At 112, the tool 12 is moved to a first position corresponding generally to a first grommet hole 18. At this first position, the imaging device 30 is oriented so that at 114 it images the first hole 18. Thereafter the data is transmitted to the vision system controller 32. At 116 the vision system controller 32 analyzes the image data and calculates the exact hole position. At 118 the hole position is transmitted to the robot controller 52. At 120 the robot 10 brings a tool projection 26 carrying a grommet 14 toward the exact location of hole 18 and inserts the grommet 14 therein. At 122, after installation, the robot retracts and positions imagining device 30 over the hole 18 having the installed grommet 14. The vision system controller 32 receives the vision signal from the imaging device 30 and determines if, at 124, grommet 14 is installed in the hole. If not, a warning may be output at 126. In one embodiment, the robot 10 may then be directed to attempt to install a grommet 14 in hole 18 again. If the vision system controller 32 determines that a grommet 14 is installed, a status update is transmitted to system controller 50 indicating the successful installation of the grommet 14. At 128 it is determined whether the last hole 18 has received a grommet 14. If so, the process ends and the robot 10 may return to grommet supplier 16. If not, process returns to 112, where the robot 10 moves to the next grommet hole 18. It should be appreciated that, if at any point in the process the tool 12 runs out of grommets 14, the robot 10 returns to the grommet supplier 16 to reload, and then begins again at the next grommet hole 18.

As will be appreciated by one of ordinary skill in the art, various functions in the present invention may be embodied as or take the form of a computer readable medium having computer-readable instructions stored thereon which, when executed by a processor, carry out the operations of the present inventions as previously described. The computer-readable medium may be any medium that can contain, store, communicate, propagate, or transport the user-interface program instruction for use by or in connection with the instruction execution system, apparatus, or device and may by way of example but without limitation, be an electronic, magnetic, optical, electromagnetic, infrared, or semiconductor system, apparatus, device, or propagation medium or other suitable medium upon which the program is printed. More specific examples (a non-exhaustive list) of the computer-readable medium would include: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Computer program code or instructions for carrying out operations of the present invention may be written in any suitable programming language provided it allows achieving the previously described technical results.

While the invention has been particularly shown and described with reference to the preferred embodiments thereof, it will be understood by those skilled in the art that various changes in form and details may be made without departing from the spirit and scope of the invention. It is intended to cover various modifications and similar arrangements and procedures, and the scope of the appended claims therefore should be accorded the broadest interpretation so as to encompass all such modifications and similar arrangements and procedures.

I claim:

1. A method of installing grommets into holes in a vehicle body using a robot system including a grommet supplier, a vision system including a vision system controller and an imaging device, and a robot having a robot arm that carries a tool and the imagine device, the method comprising:
moving the tool to the grommet supplier;
capturing a plurality of grommets using the tool;
moving the imaging device proximate to a first grommet hole in the vehicle body;
imaging the first grommet hole with the imagine device to determine a first hole location;
moving the tool to the first hole location;
installing a grommet in the first grommet hole;
moving the imagine device proximate the first grommet hole; and
imaging the first grommet hole with the imagine device to determine whether the installation of the grommet was successful.

2. The method of claim 1 wherein said tool comprises a ring shaped body having a plurality of projections extending radially therefrom, each projection including a shaped end sized to carry a single grommet.

3. The method of claim 2 wherein said step of capturing a plurality of grommets using the tool includes:
i. positioning one of said plurality of shaped ends over a grommet carried on said grommet supplier;
ii. drawing a vacuum at said shaped end positioned over the grommet;
iii. lifting the shaped end away from the grommet supplier;
iv. determining, based on the pressure at the shaped end, whether a grommet is carried in the shaped end, and if so;
v. rotating said tool to position wherein a different one of said plurality of shaped ends is positioned over a grommet carried on said grommet supplier;
vi. repeating steps ii-v until all of said plurality of shaped ends is carrying a grommet.

4. The method of claim 1 further comprising outputting an alarm if installation of the grommet was unsuccessful.

5. The method of claim 1 wherein said grommet supplier comprises a feeder track that carries grommets from a hopper to a positioning track, the grommet being positioned at an end of the positioning track when the tool captures the grommet.

6. The method of claim 1 wherein said robot is a six degree of freedom robot.

7. A robot system for installing grommets into holes in a vehicle body, the robot system comprising:
a grommet supplier having a hopper and a positioning mechanism;
a robot having a robot arm;
a vision system including a vision system controller and an imaging device, said imaging device being carried by said robot arm;
a tool carried by said robot arm, said tool including a plurality of projections, each said projection having a shaped end sized to carry a grommet;
a robot controller for controlling the robot and adapted to perform the steps of:
command the robot arm to move the tool to the grommet supplier;
command the robot arm to position the tool to capturing a plurality of grommets;
command the robot arm to move the imaging device proximate to a first grommet hole in the vehicle body;
receive a first hole location from the vision system controller;
command the robot arm to move the tool to the first hole location and install a grommet in the first grommet hole;
after installing the grommet, commanding the robot arm to move the imaging device proximate to the first grommet hole;
receive a notification from the vision system controller whether the grommet installation was successful; and
if the grommet installation was not successful, commanding the robot arm to again move the tool to the first hole location and install a grommet in the first grommet hole.

8. The system of claim 7 wherein said tool comprises a ring shaped body having a plurality of projections extending radially therefrom, each projection including a shaped end sized to carry a single grommet.

9. The system of claim 7 wherein said grommet supplier comprises a feeder track that carries grommets from a hopper to a positioning track, the grommet being positioned at an end of the positioning track when the tool captures the grommet.
